(19) United States
(12) Patent Application Publication
(10) Pub. No.: US 2019/0132712 A1
(43) Pub. Date: May 2, 2019

(54) SOCIAL PRICING METHOD

(71) Applicant: Olubayo Augustus Adekanmbi, Lagos (NG)

(72) Inventor: Olubayo Augustus Adekanmbi, Lagos (NG)

(21) Appl. No.: 15/449,932

(22) Filed: Mar. 4, 2017

Related U.S. Application Data
(60) Provisional application No. 62/400,186, filed on Sep. 27, 2016.

(51) Int. Cl. H04W 4/24; H04M 15/00

(52) U.S. Cl. CPC H04W 4/24; H04M 15/8083; H04M 15/7652; H04M 15/745

(57) ABSTRACT

The present invention may comprise a method for implementing a social pricing scheme for low-income prepaid telecommunication customers, especially in emerging markets. Incremental revenue and enhanced usage may result from priority telephone numbers for calling at an affordable price. The telecommunication service provider may recommend priority numbers, which may be selected from the contacts list of the customer, aided by algorithms that score contact relationships and relational factors among the customer, other numbers, and individual numbers saved in the contacts list. Such priority numbers may be used to assign priority values for assessing various pricing discounts.

### CROSS-REFERENCE TO RELATED APPLICATION

This application claims priority from U.S. Provisional Patent Application No. 62/400,186, filed on Sep. 27, 2016, the contents of which are incorporated herein by reference.

### BACKGROUND OF THE INVENTION

The present invention relates generally to telecommunication methods. More specifically, the present invention relates to a method for lower cost calling and messaging from a mobile device.

Calling and messaging from mobile phones are popular methods of communication worldwide. In emerging markets costs charged by telecommunication service providers (“providers”) can be relatively high, especially in locations where the providers' access to power, infrastructure, consumer base, and convenient regulation makes the costs of doing business not very competitive.

Various methods and schemes have been used to attempt to offer lower cost service while maintaining the sustainability of provider revenue and profit for the provision of calling and messaging services.

Pricing for services has been applied as a tool for enhancing competitiveness in the telecommunication industry, especially in emerging markets where revenue and profit are limited by a higher share of low-income customers, macroeconomic pressures and high multi-simming (use of multiple SIMs for price arbitrage). Various pricing approaches, like community, location, time-based, yield management-based approaches have not driven sustainable revenue growth with over 300% reduction in headline price points in many countries in the last 5 years. These methodologies did not address total unique phone numbers saved on the customers' mobile phones as an indicator of the highest possible number of phone calls that may be made in a defined period (such as in a calendar month) by the user. This is an attempt to understand the nature of calling relationships and how a recommendation engine may dynamically recommend numbers that are most likely to be called when recommended to the user at a lower tariff. Currently, various software systems have been developed related to technology including the ones related to True Caller and others where the identity of persons may be traced.

Thus, it would be advantageous to have a telephone calling and messaging system for assigning tariffs that offers discounts for more frequently called callees at specific low demand times.

As will be seen more fully below, the present invention is substantially different in process and approach from that of the prior rate provision services.

### SUMMARY OF THE INVENTION

In one aspect of the present invention, a user downloads and registers in an application with transparency and saved numbers on the user's mobile phone are uploaded into the application. A back-end algorithm in the application operates and chooses from two lists, Called Numbers and Uncalled Numbers over a defined period of time, such as during the previous 90 days.

In another aspect of the present invention, a system performs a social network analysis to analyse any uncalled numbers to determine which numbers have a high likelihood of being apparently significant (e.g., “crucial”) to the customers and might be called when recommended at discounted rates. The analysis checks the tie pattern involving the uncalled phone numbers with the highest ties with the called numbers being tagged as “socially relevant” and ties are further profiled on average revenue per user, location (such as by GPS) and device type to ensure there is a high similarity. The numbers with a higher likelihood of being called are stored for push notification via an application optionally with a personalised message showing the name/number of the recommended discounted call, discounted rates and validity periods of the special offer.

In yet another aspect of the present invention, a method for providing telephone communication service comprises: launching a software application installed on a mobile communication device of a calling party, dialing a destination telephone number, establishing a connection over a mobile data network between the software application and an application server, identifying a first person associated with the mobile communication device located in an area of interest, wherein the identifying occurs at a location and messaging center, wherein the area of interest is a geographical area around an event and is determined by an area of interest establisher associated with the messaging center located remote from the mobile communication device, identifying a contact person associated with the first person, wherein the contact person is authorized to receive information about the first person; and providing information to the contact person that the mobile communication device associated with the first person is located in the area of interest and directing the contact person to a location for more information regarding a status of the first person and the area of interest.

In a further aspect of the present invention, a system for providing communication services comprises; a module for storing a discount plan defining individual critical numbers for the discount plan, module for selectively providing communication services to a user in the discount plan based on the critical numbers defined for the discount plan, module for selectively providing communication services to a user in the discount plan based on the local time of the user, module for selectively providing communication services to a user in the discount plan based on telecommunications system traffic, wherein the module for selectively providing communication services comprises: means for monitoring calling attempts relative to critical numbers of the discount plan, means for monitoring calling attempts relative to current time relative to the user's local time, means for monitoring calling attempts relative to telecommunications system traffic, and completing a calling attempt according to the discount plan according to a protocol of the discount plan.

In a still further aspect of the present invention, a non-transitory machine-readable medium comprises; a plurality of machine-readable instructions which when executed by one or more processors of a server are adapted to cause the server to perform a method comprising: storing user account information for a plurality of users in a memory, the user account information including an indication as to which group of a plurality of groups a user belongs, wherein each of the groups contains a plurality of users, receiving an indication of a discount provided or to be provided to a user, accessing a user account, identifying from the user account information to which of the groups the user belongs, determining the identifications of other members of the group, and facilitating communication of the discount to the user, and connecting the user with another user according to a discount plan protocol.

These and other aspects, objects, features and advantages of the present invention are specifically set forth in or will become apparent from, the following detailed description of an exemplary embodiment of the invention when read in conjunction with the accompanying drawings.

### BRIEF DESCRIPTION OF THE DRAWINGS

FIG. 1 is a flow chart illustrating a method, according to an embodiment of the present invention;

FIG. 2 is a flow chart illustrating a method, according to another embodiment of the present invention; and

FIG. 3 is a flow chart illustrating a method, according to yet another embodiment of the present invention.

### DETAILED DESCRIPTION OF THE INVENTION

The following detailed description is of the best currently contemplated modes of carrying out the invention. The description is not to be taken in a limiting sense but is made merely for the purpose of illustrating the general principles of the invention, since the scope of the invention is best defined by the appended claims.

Although the invention is often referred to herein as a telephone calling feature, it is understood that such description is not limiting, such that the technology in this invention may be applied in numerous other products and methods, including but not limited to texting, messaging, video conferencing, remote communication, broadcasting, e-mailing, faxing, or other situations for communication transactions. In general, the order of the steps of disclosed processes may be altered within the scope of the invention.

Mobile phones also have the option of recommending frequently ‘called’ numbers or contacts but the innovation described in the present invention of suggesting discounted calls that increase usage, maintain a customer base, grow billable calling minutes and increasing social connectivity even for low-income customers is novel.

The present invention is an improvement by supplying a methodology of incentivizing customers to call more phone numbers at discounted tariffs on selected days when network headroom is ensured and based on yield management principles, where unused network capacity is wasted if not used and may be profitable when sold at the lowest possible discount. At present, an average customer has around 100 contact numbers saved on a mobile phone and out of which the customer only engages with 15 “crucial” contact numbers every month. The present invention may be related to the assumption that a saved number in the user's phonebook has some kind of social or emotional relevance to the user and as many as much as 20 of the perhaps 85 uncalled numbers may also be important to a customer to call, especially when a trigger system recommends numbers that have strong social ties within the customers' calling history and thus most likely to be called at discounted tariff. Therefore, this approach can improve the current operational practice from the traditional one-to-one model (where the companies look at one customer calling relationship with other customers like “Friends and Family” programs) to one-to-many-to-one (when the companies may also look at the inter-relationships between phone numbers that a customer calls or receives from in order to determine the homophilic or heterophilic network of a customer for social value optimization—the basis to determine the discounted tariff for every single phone numbers saved on the customer's phone). The present invention may be useful for increasing revenue and customer activity level by increasing the total unique calls made by low-income customers who are known to be discount-hunters and yet very relationship-oriented.

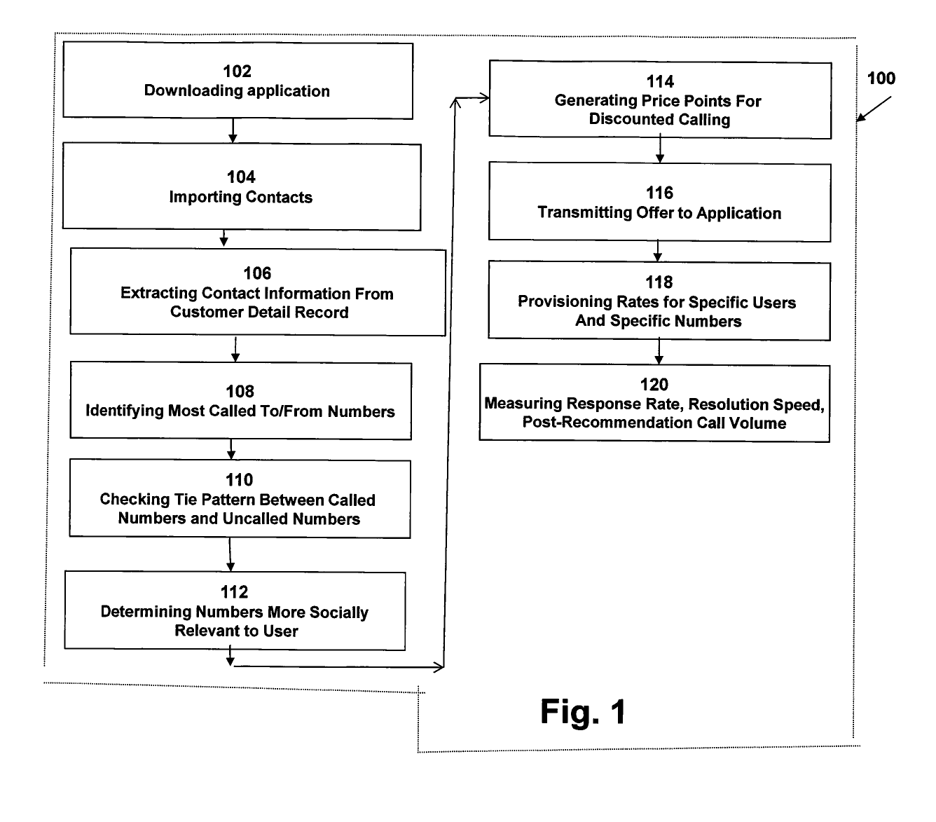

As shown in FIG. 1, one aspect of the present invention may comprise a method 100 wherein a Step 102 includes a user downloading and registering an application with transparency and saved numbers on the user's mobile phone are uploaded into the application. A Step 104 may comprise importing contacts while a Step 106 may comprise extracting contact information from a customer detail record. Identifying most called to/from numbers may comprise Step 108. A back-end algorithm in the application operates and chooses from two lists, Called Numbers and Uncalled Numbers over a defined period of time, such as during the previous 90 days. Step 110 of Method 100 may comprise checking tie pattern between called numbers and uncalled numbers. Step 112 may comprise determining numbers more socially relevant to a user. Step 114 may comprise generating price points for discounted calling. Transmitting an offer to the application may comprise Step 116 while Step 118 provisioning rates for specific users and specific numbers. A Step 120 may comprise measuring response rates, resolution speeds, and/or post-recommendation call volumes.

The method 100 may also comprise receiving user information regarding the first person from a communication provider associated with the mobile communication device and using the user information for identifying the contact person. Also, the method 100 may comprise providing a request for user information to the mobile communication device within the area of interest, the request consisting of: a user identity confirmation, a specific location, and a list of any other persons with a user; and receiving a response from the mobile communication device.

The method 100 may comprise the contact person being one of a plurality of persons listed in a discount plan associated with a communication provider for the mobile communication device.

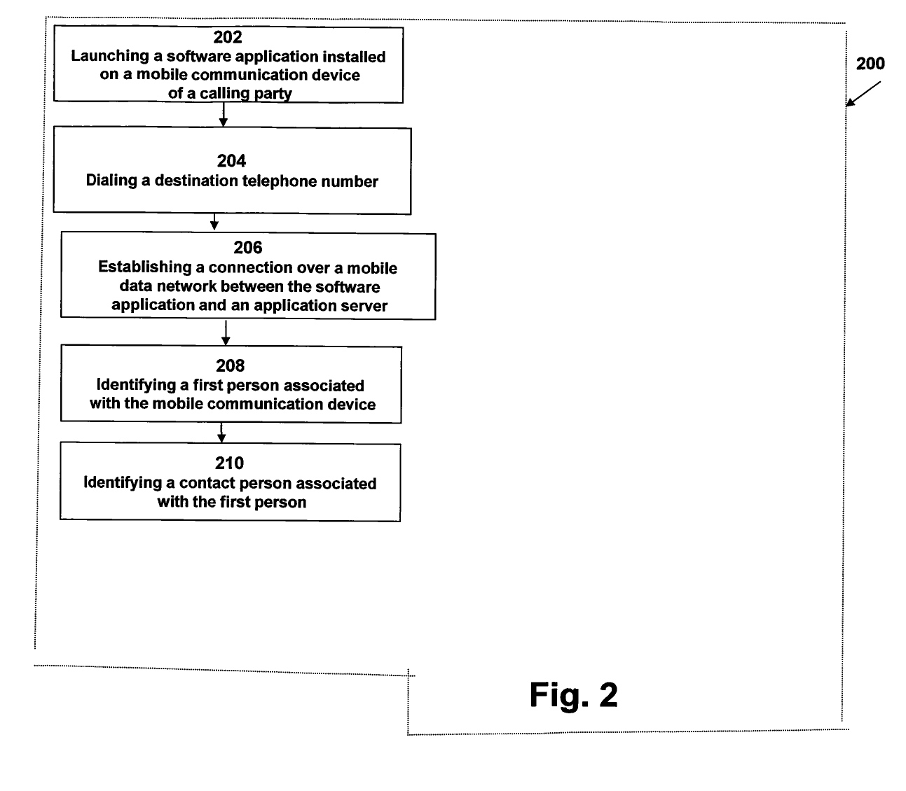

With reference to FIG. 2, a method 200 may comprise a method for providing telephone communication service comprises: a Step 202 of launching a software application installed on a mobile communication device of a calling party, a Step 204 of dialing a destination telephone number, a Step 206 for establishing a connection over a mobile data network between the software application and an application server, a Step 208 for identifying a first person associated with the mobile communication device located in an area of interest, wherein the identifying occurs at a location and messaging center, wherein the area of interest is a geographical area around an event and is determined by an area of interest establisher associated with the messaging center located remote from the mobile communication device, and a Step 210 of identifying a contact person associated with the first person, wherein the contact person is authorized to receive information about the first person; and providing information to the contact person that the mobile communication device associated with the first person is located in the area of interest and directing the contact person to a location for more information regarding a status of the first person and the area of interest.

A system may perform a social network analysis to analyse any uncalled numbers to determine which numbers have a high likelihood of being apparently significant (e.g., “crucial”) to the customers and might be called when recommended at discounted rates. The analysis checks the tie pattern involving the uncalled phone numbers with the highest ties with the called numbers being tagged as “socially relevant” and ties are further profiled on average revenue per user, location (such as by GPS) and device type to ensure there is a high similarity. The numbers with a higher likelihood of being called are stored for push notification via an application optionally with a personalised message showing the name/number of the recommended discounted call, discounted rates and validity periods of the special offer.

In a further aspect of the present invention, a system for providing communication services comprises; a module for storing a discount plan defining individual critical numbers for the discount plan, module for selectively providing communication services to a user in the discount plan based on the critical numbers defined for the discount plan, module for selectively providing communication services to a user in the discount plan based on the local time of the user, module for selectively providing communication services to a user in the discount plan based on telecommunications system traffic, wherein the module for selectively providing communication services comprises: means for monitoring calling attempts relative to critical numbers of the discount plan, means for monitoring calling attempts relative to current time relative to the user's local time, means for monitoring calling attempts relative to telecommunications system traffic, and completing a calling attempt according to the discount plan according to a protocol of the discount plan.

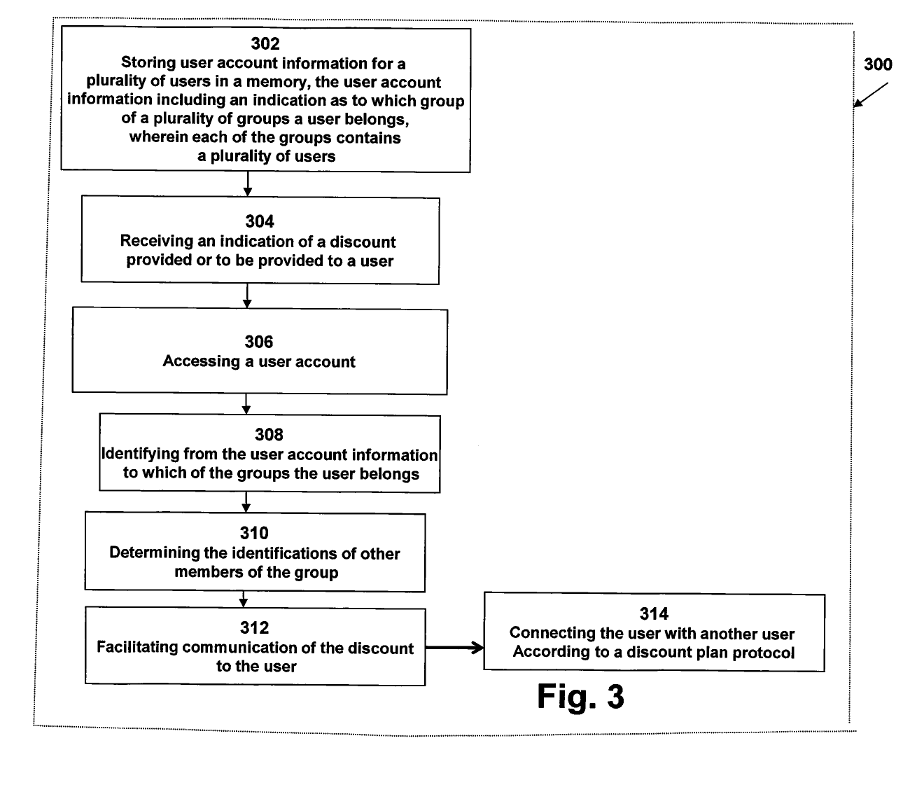

A non-transitory machine-readable medium may comprise a plurality of machine-readable instructions which when executed by one or more processors of a server are adapted to cause the server to perform a method 300, as shown in FIG. 3. The method 300 may comprise: a Step 302 of storing user account information for a plurality of users in a memory, the user account information including an indication as to which group of a plurality of groups a user belongs, wherein each of the groups contains a plurality of users; a Step 304 for receiving an indication of a discount provided or to be provided to a user; a Step 306 of accessing a user account; a Step 308 of identifying from the user account information to which of the groups the user belongs; a Step 310 of determining the identifications of other members of the group; a Step 312 of facilitating communication of the discount to the user; and a Step 314 of connecting the user with another user according to a discount plan protocol.

The method 300 may be modified or altered to comprise more aspects, concurrent steps, simultaneous steps, or other variations, such as wherein the method comprises defining individual critical numbers of the user according to the discount plan protocol. Another aspect may occur wherein the method 300 comprises communicating an identification of the other users of the group to a mobile device of the user. In a yet further aspect, the method 300 may comprise members of the group sharing a mobile service plan, such as if the group is a family. Another possibility occurs wherein a system communicates discount details to the user. One variation may comprise communicating the discount details to a predetermined subset of other members of the group. Another option is wherein a list of members of the group to whom the discount applies is stored in a cloud.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

The flowcharts illustrated in FIGS. 1-3 are exemplary and are simplified for sake of clarity. In some implementations, additional blocks/tasks/steps may be implemented even though they are not illustrated for sake of clarity. These additional blocks/tasks/steps may occur before or after or in parallel and/or concurrently with any of the blocks/tasks/steps that are illustrated in FIGS. 1-3. It is also noted that some of the blocks/tasks/steps illustrated in FIGS. 1-3 may be optional and do not need to be included in every implementation of the disclosed embodiments. In some implementations, although not illustrated, the presence or absence of certain conditions may need to be confirmed prior to execution of a block/task/step or before completion of a block/task/step. In other words, a block/task/step may include one or more conditions that are to be satisfied before proceeding from that block/task/step to the next block/task/step of FIGS. 1-3. For example, in some cases, a timer, a counter or combination of both may execute and need to be satisfied before proceeding to the next block/task/step of the flowchart. As such, any block/task/step can be conditional on other blocks/tasks/steps that are not illustrated in FIGS. 1-3.

It is also noted that there is no order or temporal relationship implied by the flowcharts of FIGS. 1-3 unless the order or temporal relationship is expressly stated or implied from the context of the language that describes the various blocks/tasks/steps of the flowchart. The order of the blocks/tasks/steps may be varied unless expressly stated or otherwise implied from other portions of text.

In addition, in some implementations, FIGS. 1-3 may include additional feedback or feed-forward loops that are not illustrated for sake of clarity. The absence of a feedback or a feed-forward loop between two points of the flowchart does not necessarily mean a feedback or feed-forward loop is not present between the two points. Likewise, some feedback or feed-forward loops may be optional in certain implementations. Although FIGS. 1-3 are illustrated as including a single iteration this does not necessarily imply that the flowchart does not execute for a certain number of iterations or continuously or until one or more conditions occur.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” and such simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for providing telephone communication service, comprising:
launching a software application installed on a mobile communication device of a calling party;
dialing a destination telephone number;
establishing a connection over a mobile data network between the software application and an application server;
identifying a first person associated with the mobile communication device located in an area of interest, wherein the identifying occurs at a location and messaging center, wherein the area of interest is a geographical area around an event and is determined by an area of interest establisher associated with the messaging center located remotely from the mobile communication device; and
identifying a contact person associated with the first person, wherein the contact person is authorized to receive information about the first person; and providing information to the contact person that the mobile communication device associated with the first person is located in the area of interest and directing the contact person to a location for more information regarding a status of the first person and the area of interest.

2. The method of claim 1 wherein the identifying the first person further comprises:
receiving user information regarding the first person from a communication provider associated with the mobile communication device and using the user information for the identifying the contact person.

3. The method of claim 1 wherein the identifying the first person further comprises:
providing a request for user information to the mobile communication device within the area of interest, the request consisting of: a user identity confirmation, a specific location, and a list of any other persons with a user; and
receiving a response from the mobile communication device.

4. The method of claim 1 wherein said contact person is one of a plurality of persons listed in a discount plan associated with a communication provider for the mobile communication device.

5. A system for providing communication services, comprising:
a module for storing a discount plan defining individual critical numbers for the discount plan;
module for selectively providing communication services to a user in the discount plan based on the critical numbers defined for the discount plan;
module for selectively providing communication services to a user in the discount plan based on the local time of the user;
module for selectively providing communication services to a user in the discount plan based on telecommunications system traffic;
wherein the module for selectively providing communication services comprises:
means for monitoring calling attempts relative to critical numbers of the discount plan;
means for monitoring calling attempts relative to current time relative to the user's local time;
means for monitoring calling attempts relative to telecommunications system traffic; and
completing a calling attempt according to the discount plan according to a protocol of the discount plan.

6. A non-transitory machine-readable medium, comprising:
a plurality of machine-readable instructions which when executed by one or more processors of a server are adapted to cause the server to perform a method comprising:
storing user account information for a plurality of users in a memory, the user account information including an indication as to which group of a plurality of groups a user belongs, wherein each of the groups contains a plurality of users;
receiving an indication of a discount provided or to be provided to a user;
accessing a user account;
identifying from the user account information to which of the groups the user belongs;
determining the identifications of other members of the group;
facilitating communication of the discount to the user; and
connecting the user with another user according to a discount plan protocol.

7. The non-transitory machine-readable medium of claim 6, wherein the method comprises defining individual critical numbers of the user according to the discount plan protocol.

8. The non-transitory machine-readable medium of claim 6, wherein the method comprises communicating an identification of the other users of the group to a mobile device of the user.

9. The non-transitory machine-readable medium of claim 6, wherein all members of the group share a mobile service plan.

10. The non-transitory machine-readable medium of claim 6, wherein the group is a family.

11. The non-transitory machine-readable medium of claim 6, wherein the method comprises communicating discount details to the user.

12. The non-transitory machine-readable medium of claim 11, further comprising communicating the discount details to a predetermined subset of other members of the group.

13. The non-transitory machine-readable medium of claim 6, wherein a list of members of the group to whom the discount applies is stored in a cloud.
